(19) United States
(12) Patent Application Publication
(10) Pub. No.: US 2024/0054330 A1
(43) Pub. Date: Feb. 15, 2024

(54) EXPLOITATION OF LOW DATA DENSITY OR NONZERO WEIGHTS IN A WEIGHTED SUM COMPUTER

(71) Applicant: COMMISSARIAT A L’ENERGIE ATOMIQUE ET AUX ENERGIES ALTERNATIVES, PARIS (FR)

(72) Inventor: Michel HARRAND, GRENOBLE (FR)

(21) Appl. No.: 18/267,070

(22) PCT Filed: Dec. 15, 2021
(86) PCT No.: PCT/EP2021/085864

§ 371 Date: Jun. 13, 2023

(30) Foreign Application Priority Data
Dec. 16, 2020 (FR) 2013363

(51) Int. Cl. G06N 3/063

(52) U.S. Cl. CPC G06N 3/063

(57) ABSTRACT

A computing circuit for computing a weighted sum of a set of first data using at least one parsimony management circuit includes a first buffer memory for storing all or some of the first data delivered sequentially and a second buffer memory for storing all or some of the second data delivered sequentially. The parsimony management circuit furthermore comprises a first processing circuit able: to analyze the first data in order to search for the first non-zero data and define a first skip indicator between two successive non-zero data, and to control the transfer, to the distribution circuit, of a first datum read from the first data buffer memory on the basis of the first skip indicator. The parsimony management circuit furthermore comprises a second processing circuit able to control the transfer, to the distribution circuit, of a second datum read from the second data buffer memory on the basis of the first skip indicator.

### CROSS-REFERENCE TO RELATED APPLICATIONS

This application is a National Stage of International patent application PCT/EP2021/085864, filed on Dec. 15, 2021, which claims priority to foreign French patent application No. FR 2013363, filed on Dec. 16, 2020, the disclosures of which are incorporated by reference in their entirety.

### FIELD OF APPLICATION

The invention relates in general to circuits for computing weighted sums of data having a low data density or non-zero weighting weights, and more particularly to digital neuromorphic network computers for computing artificial neural networks based on convolutional or fully connected layers.

### BACKGROUND

Artificial neural networks are computer models that mimic the operation of biological neural networks. Artificial neural networks comprise neurons that are interconnected with one another by synapses, which are for example implemented by digital memories. Artificial neural networks are used in various fields of signal processing (visual signals, sound signals or the like), such as for example in the field of image classification or image recognition.

Convolutional neural networks correspond to a particular model of artificial neural network. Convolutional neural networks were first described in the article by K. Fukushima, “Neocognitron: A self-organizing neural network model for a mechanism of pattern recognition unaffected by shift in position. Biological Cybernetics, 36(4):193-202, 1980. ISSN 0340-1200. doi: 10.1007/BF00344251”.

Convolutional neural networks (also referred to using the expressions “deep (convolutional) neural networks” or else “ConvNets”) are neural networks inspired by biological visual systems.

Convolutional neural networks (CNN) are used notably in image classification systems to improve classification. Applied to image recognition, these networks make it possible to learn intermediate representations of objects in images that are smaller and able to be generalized for similar objects, thereby facilitating recognition thereof. However, the intrinsically parallel operation and the complexity of convolutional neural network-type classifiers makes them difficult to implement in embedded systems with limited resources. Indeed, embedded systems impose strong constraints with respect to the surface area of the circuit and electrical consumption.

The convolutional neural network is based on a succession of layers of neurons, which may be convolutional layers or fully connected layers (generally at the end of the network). In convolutional layers, only a subset of neurons of one layer is connected to a subset of neurons of another layer. Moreover, convolutional neural networks are able to process multiple input channels so as to generate multiple output channels. Each input channel corresponds for example to a different data matrix.

Input images in raster form are present on the input channels, thus forming an input matrix, an output raster image is obtained on the output channels.

The matrices of synaptic coefficients for a convolutional layer are also called “convolution kernels”.

In particular, convolutional neural networks comprise one or more convolution layers that are particularly costly in terms of number of operations. The operations that are performed are mainly multiply-accumulate (MAC) operations for computing a sum of the data weighted by the synaptic coefficients. Moreover, to comply with latency and processing time constraints specific to the targeted applications, it is necessary to minimize the number of computing cycles necessary in an inference phase or in a backpropagation phase during training of the network.

More particularly, when convolutional neural networks are implemented in an embedded system with limited resources (as opposed to an implementation in data center infrastructures), the reduction in electrical consumption and the reduction in the number of necessary computing operations becomes an essential criterion for implementing the neural network.

The basic operation implemented by an artificial neuron is a multiply-accumulate operation MAC. Depending on the number of neurons per layer and layers of neurons contained in the network, the number of MAC operations per unit of time necessary for real-time operation becomes restrictive.

There is therefore a need to develop computing architectures that are optimized for neural networks and that make it possible to limit the number of MAC operations without degrading either the performance of the algorithms implemented by the network or the precision of the computations. More particularly, there is a need to develop computing architectures that are optimized for neural networks and that carry out weighted sum computations while avoiding operations of multiplying by a zero datum received by a neuron and/or by a zero synaptic coefficient.

The publication “Eyeriss v2: A Flexible Accelerator for Emerging Deep Neural Networks on Mobile Devices” by Chen et al. presents a convolutional neural network computer implementing a network-on-chip (NoC) circuit for processing low data density and non-zero weights. However, the drawback of this solution is the use of a very bulky network-on-chip type circuit occupying a large surface area in an integrated circuit.

The publication “An 11.5TOPS/W 1024-MAC Butterfly Structure Dual-Core Sparsity-Aware Neural Processing Unit in 8 nm Flagship Mobile SoC” by Jinook Song et al. presents a convolutional neural network computer implementing a selection of the data to be read based on the low density of non-zero weights by using a pre-computation of the indices of the non-zero weights. The drawback of this solution is its limitation to exploiting the low density of non-zero weights only. In addition, the solution proposed by that publication is limited to inference operation, which is not suitable for implementing a learning phase.

### Response to the Problem and Provision of a Solution

The invention proposes a computer architecture that makes it possible to reduce the electrical consumption and improve the performance of a neural network implemented on a chip using a flow management circuit integrated into the same chip as the computing network. The flow management circuit according to the invention exploits the low density of non-zero data and/or non-zero weights.

The invention proposes an artificial neural network accelerator computer architecture comprising a plurality of MAC computing units each receiving, in each computing cycle, a non-zero datum and the synaptic coefficient associated with said datum, or vice versa. The improvement in computing performance is achieved by way of at least one flow management circuit that makes it possible to identify the zero data when they are loaded from a data memory and to synchronize the reading of the weights from a weight memory by way of skip information. The solution according to the invention furthermore proposes processing of the low density of non-zero data jointly for the data and the synaptic coefficients (or weights). It is conceivable in the solution according to the invention to carry out this joint processing on vectors each comprising a plurality of pairs of type [data, weight].

In the description of the invention, we will present the proposed technical solution in the context of a neuromorphic network computer. However, the proposed solution is suitable, more generally, for any computing architecture intended to carry out multiply-accumulate (MAC) operations in order to compute sums of a first type of data A weighted with a second type of data B.

The solution proposed according to the invention is optimum when the first type of data A and/or the second type of data B have a low density of non-zero values. The solution proposed according to the invention is symmetric with respect to the type of data A or B.

More generally, the solution according to the invention makes it possible to take into account the “low density of non-zero data” of at least one of the input data of a series of MAC operations. This makes it possible to optimize the operation of the computer carrying out the MAC operations via parsimonious computing that limits the energy consumption and the computing time required.

In the following sections, the term “sparsity” has been denoted parsimony, also referring to the concept of “low density of non-zero data”.

### SUMMARY OF THE INVENTION

The subject of the invention is a computing circuit for computing a weighted sum of a set of first data weighted by a set of second data comprising:
At least one first data memory for storing the first data;
At least one second data memory for storing the second data;
At least one computing unit configured to carry out the weighted sum computation;
At least one first sequencer circuit able to control reading from the first data memory according to a first predefined addressing sequence;
At least one second sequencer circuit able to control reading from the second data memory according to a second predefined addressing sequence;
At least one distribution circuit (DIST) associated with a computing unit for successively delivering thereto a new pair of associated first and second data;
At least one flow management circuit comprising:
A first buffer memory for storing all or some of the first data delivered sequentially by said first sequencer circuit;
A second buffer memory for storing all or some of the second data delivered sequentially by said second sequencer circuit;
a first processing circuit comprising a first circuit for controlling read and write pointers of the first buffer memory and being able:
to analyze the first data delivered by said first sequencer circuit in order to search for the first non-zero data and define a first skip indicator between two successive non-zero data, and
to control the transfer, to the distribution circuit, of a first datum read from the first data buffer memory on the basis of said first skip indicator;
a second processing circuit comprising a second circuit for controlling read and write pointers of the second buffer memory and being able to control the transfer, to the distribution circuit, of a second datum read from the second data buffer memory on the basis of said first skip indicator.

According to one particular aspect of the invention, the computing circuit furthermore comprises a plurality of zero datum detection circuits each configured to pair, with each first input datum, a zero datum indicator having a first state corresponding to a zero datum and a second state corresponding to a non-zero datum.

According to one particular aspect of the invention, the first sequencer circuit is configured to deliver the first data in vectors of N successive data, N being a non-zero natural integer. The first buffer memory is a memory able to store vectors of N data in accordance with a “first in first out” principle. The first processing circuit comprises a data parsimony management stage intended to receive the vectors from the first buffer memory and configured to generate a word skip signal between two successive non-zero data intended for the two pointer control circuits. Said word skip signal forms a first component of the first skip indicator.

According to one particular aspect of the invention, the first processing circuit comprises, upstream of the first buffer memory, a vector parsimony management stage configured to generate a vector skip signal intended for the two pointer control circuits when a vector is zero. Said vector skip signal forms a second component of the first skip indicator.

According to one particular aspect of the invention, the vector parsimony management stage comprises a first zero vector detection logic circuit configured to generate, from the zero datum indicators, the vector skip signal when a vector comprises only zero data.

According to one particular aspect of the invention, the data parsimony management stage comprises:
A register for receiving a non-zero vector at the output of the first buffer memory;
A priority encoder stage configured to carry out the following operations iteratively:
generating a distribution control signal corresponding to the index of the first non-zero input datum of the vector.
   The first pointer control circuit is configured to carry out the following in the same iteration loop:
generating the word skip signal from the distribution control signal;
and setting the zero datum indicator of the input datum distributed in the vector stored in the register to the first state following distribution thereof.
   The data parsimony management stage comprises a second zero vector detection logic circuit for generating a signal for triggering reading of the following vector when all of the zero datum indicators of the data belonging to said vector are in the first state.

According to one particular aspect of the invention, the second processing circuit is able:
to analyze the second data delivered by said second sequencer circuit in order to search for the second zero data and define a second skip indicator between two successive non-zero data, and
to control the transfer, to the distribution circuit, of a second datum read from the second data buffer memory on the basis of said first and second skip indicators.

The second processing circuit is able to control the transfer, to the distribution circuit, of a second datum read from the second data buffer memory on the basis of said first and second skip indicators.

According to one particular aspect of the invention, the flow management circuit is configured to read the data from the two memories in vectors of N successive pairs according to the first and the second predefined addressing sequence of said data, N being a non-zero natural integer. The first and second skip indicator are obtained by analyzing said vectors such that the two data forming a distributed pair are non-zero.

According to one particular aspect of the invention, the computing circuit furthermore comprises a plurality of zero pair detection circuits each configured to pair, with each pair of first and second input data, a zero pair indicator having a first state corresponding to a pair comprising at least one zero datum and a second state corresponding to a pair comprising only non-zero data.

According to one particular aspect of the invention, the assembly formed by the first and the second buffer memory is a memory able to store vectors of N pairs in accordance with a “first in first out” principle. The assembly formed by the first and the second processing circuit comprises a data parsimony management stage intended to receive the vectors from the assembly of the first and the second buffer memory and configured to generate a word skip signal between two successive pairs having two non-zero data intended for the two pointer control circuits. Said word skip signal forms a first component of the first skip indicator and of the second skip indicator.

According to one particular aspect of the invention, the computing circuit comprises a vector parsimony management stage upstream of the first and the second buffer memory. The vector parsimony management stage comprises a first zero vector detection logic circuit configured to generate a vector skip signal when a vector comprises only zero datum indicators in the first state. Said vector skip signal forms a second component of the first skip indicator and of the second skip indicator.

According to one particular aspect of the invention, the pair parsimony management stage comprises:
A register for receiving a non-zero vector at the output of the buffer memory;
A priority encoder stage configured to carry out the following operations iteratively:
Generating a distribution control signal corresponding to the index of the first pair having two non-zero data of the vector;
   At least the first or the second pointer control circuit being configured to carry out the following in the same iteration loop:
setting the zero datum indicator of the pair of input data distributed in the vector stored in the register to the first state, following distribution thereof;
A distribution member controlled by the distribution control signal;
A second zero vector detection logic circuit for generating a signal for triggering reading of the following vector when all of the zero datum indicators of the pairs belonging to said vector are in the first state.

According to one particular aspect of the invention, the computing circuit is intended to compute output data of a layer of an artificial neural network from input data. The neural network is formed of a succession of layers each consisting of a set of neurons. Each layer is connected to an adjacent layer via a plurality of synapses associated with a set of synaptic coefficients forming at least one weight matrix.

The first set of data corresponds to the input data for a neuron of the layer currently being computed. The second set of data corresponds to the synaptic coefficients connected to said neuron of the layer currently being computed. The computing circuit comprises:
at least one group of computing units, each group of computing units comprising a plurality of computing units of rank k=1 to K, with K a strictly positive integer,
a plurality of second data memories of rank k=1 to K for storing the second set of data;

Each group of computing units is connected to a dedicated flow management circuit furthermore comprising: a plurality of second buffer memories of rank k=1 to K such that each second buffer memory distributes, to the computing unit of the same rank k, the input data from the second data memory of the same rank k on the basis of at least the first skip indicator.

According to one particular aspect of the invention, the computing circuit is intended to compute output data of a layer of an artificial neural network from input data. The neural network is formed of a succession of layers each consisting of a set of neurons. Each layer is connected to an adjacent layer via a plurality of synapses associated with a set of synaptic coefficients forming at least one weight matrix.

The first set of data corresponds to the synaptic coefficients connected to said neuron of the layer currently being computed. The second set of data corresponds to the input data for a neuron of the layer currently being computed. The computing circuit comprises:
at least one group of computing units, each group of computing units comprising a plurality of computing units of rank k=1 to K, with K a strictly positive integer,
a plurality of first data memories of rank k=1 to K for storing the first set of data,
A plurality of flow management circuits of rank k=1 to K, each configured such that, for each computing unit of rank k belonging to a group of computing units:
the flow management circuit of rank k is configured to distribute the non-zero synaptic coefficients from the first data memory of the same rank k to the computing unit of the same rank k.

### BRIEF DESCRIPTION OF THE DRAWINGS

Other features and advantages of the present invention will become more clearly apparent on reading the following description with reference to the following appended drawings.

FIG. 1 shows one example of a convolutional neural network containing convolutional layers and fully connected layers.

FIG. 2a shows a first illustration of the operation of a convolution layer of a convolutional neural network with one input channel and one output channel.

FIG. 2b shows a second illustration of the operation of a convolution layer of a convolutional neural network with one input channel and one output channel.

FIG. 2c shows an illustration of the operation of a convolution layer of a convolutional neural network with multiple input channels and multiple output channels.

FIG. 3 illustrates one example of a block diagram of the general architecture of a computing circuit of a convolutional neural network.

FIG. 4 illustrates a block diagram of one example of a computing network implemented on a system-on-chip according to the invention.

FIG. 5a illustrates a block diagram of a flow management circuit CGF exploiting the low density of non-zero values according to the invention.

FIG. 5b illustrates a block diagram of a data flow management circuit according to a first embodiment in which the parsimony analysis is carried out only on one set of data.

FIG. 5c illustrates one exemplary implementation of the first embodiment of the invention.

FIG. 6a illustrates a block diagram of a data flow management circuit according to a second embodiment in which the parsimony analysis is carried out jointly on both sets of data.

FIG. 6b illustrates a block diagram of a data flow management circuit according to a third embodiment in which the parsimony analysis is carried out jointly on both sets of data.

### DETAILED DESCRIPTION

It will be recalled that the solution described by the invention is applicable to any computing circuit carrying out multiply-accumulate operations to compute a sum of a first set of data A weighted by a second set of data B. By way of illustration and without loss of generality, a description will be given of the technical solution according to the invention implemented in a circuit configured for a convolutional artificial neural network computing application.

We will first begin by describing one example of the overall structure of a convolutional neural network containing convolutional layers and fully connected layers.

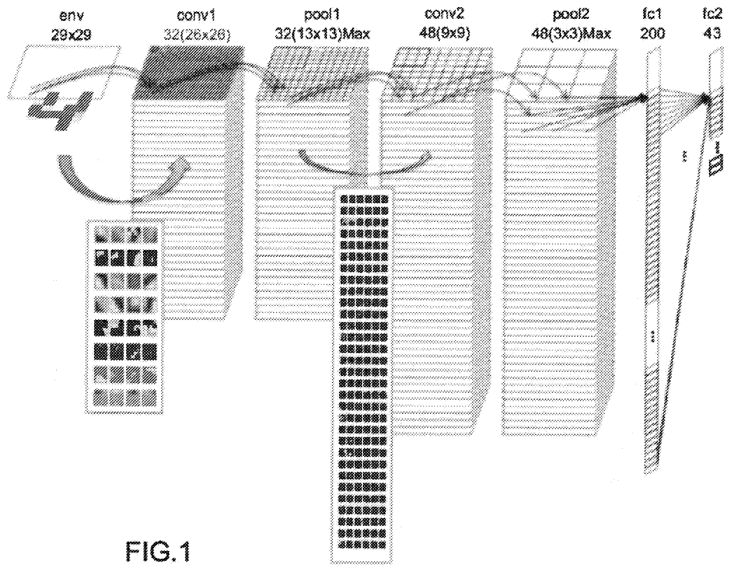

FIG. 1 shows the overall architecture of one example of a convolutional network for image classification. The images at the bottom of FIG. 1 depict an extract of the convolution kernels of the first layer. An artificial neural network (also called “formal” neural network or simply referred to using the expression “neural network” below) consists of one or more layers of neurons that are interconnected with one another.

Each layer consists of a set of neurons, which are connected to one or more previous layers. Each neuron of a layer may be connected to one or more neurons of one or more previous layers. The last layer of the network is called “output layer”. The neurons are connected to one another by synapses associated with synaptic weights, which weight the efficiency of the connection between the neurons, and constitute the adjustable parameters of a network. The synaptic weights may be positive or negative.

Neural networks called “convolutional” neural networks (or else “deep convolutional” networks or “convents”) are also formed of layers of specific types such as convolution layers, pooling layers and fully connected layers. By definition, a convolutional neural network comprises at least one convolution layer or “pooling” layer.

The architecture of the accelerator computer circuit according to the invention is compatible for carrying out convolutional layer computations. We will first begin by detailing the computations performed for a convolutional layer.

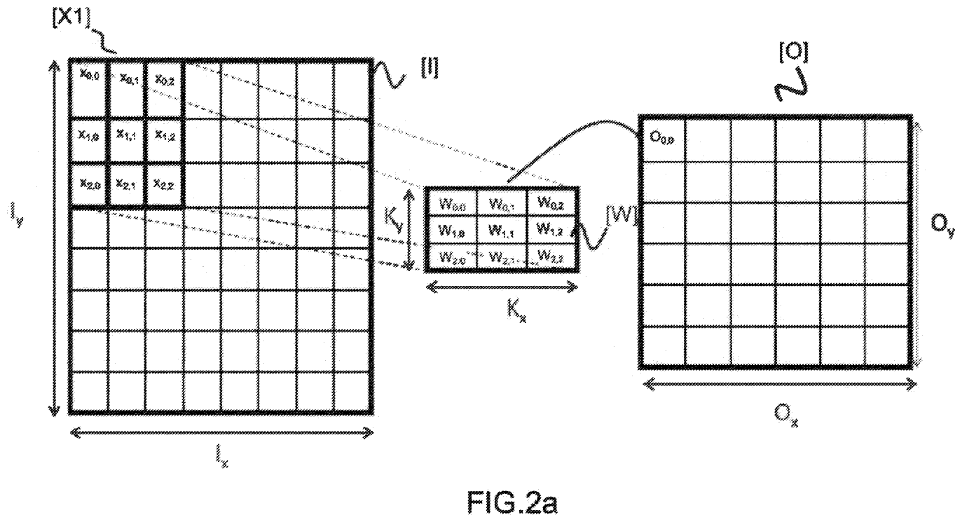

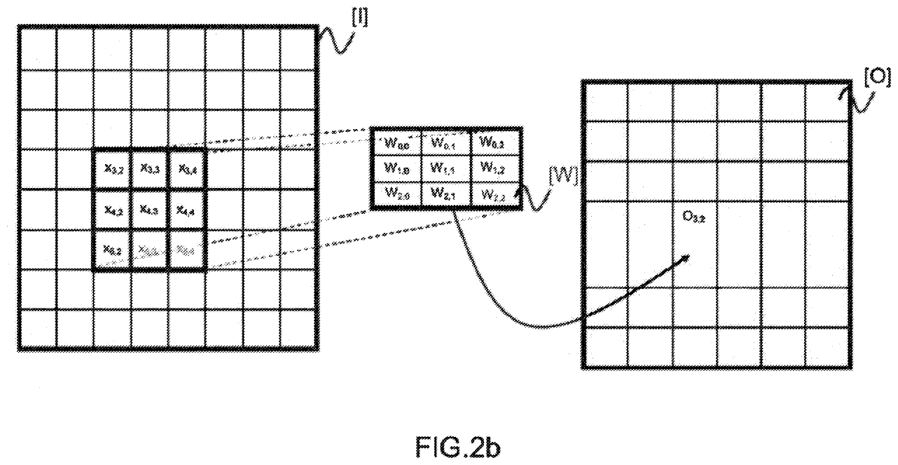

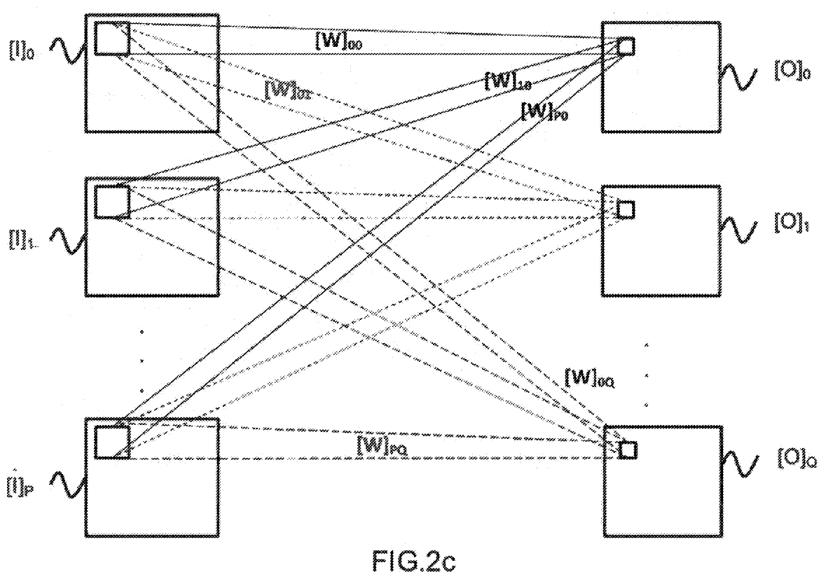

FIGS. 2a-2c illustrate the general operation of a convolution layer.

FIG. 2a shows an input matrix [I] of size (I_{×},I_{y}) connected to an output matrix [O] of size (Oₓ,O_{y}) via a convolution layer carrying out a convolution operation using a filter [W] of size (K_{×},K_{y}).

A value O_{i,j} of the output matrix [O] (corresponding to the output value of an output neuron) is obtained by applying the filter [W] to the corresponding sub-matrix of the input matrix [I].

Generally speaking, a definition is given of the convolution operation with the symbol ⊗ between two matrices [X] formed by the elements x_{i,j} and [Y] formed by the elements y_{i,j} of equal dimensions. The result is the sum of the products of the coefficients x_{i,j}·y_{i,j} each having the same position in the two matrices.

FIG. 2a shows the first value O_{0,0} of the output matrix [O] obtained by applying the filter [W] to the first input sub-matrix denoted [X1] of dimensions equal to that of the filter [W]. The detail of the convolution operation is described by the following equation:

O_{0,0}=[x1]⊗[W]

Hence

O_{0,0}=x₀₀·w₀₀+x₀₁·w₀₁+x₀₂·w₀₂+x₁₀·w₁₀+x₁₁·w₁₁+x₁₂·w₁₂+x₂₀·w₂₀+x₂₁·w₂₁+x₂₂·w₂₂.

FIG. 2b shows a general case of computing an arbitrary value O_{3,2} of the output matrix.

Generally speaking, the output matrix [O] is connected to the input matrix [I] by a convolution operation, via a convolution kernel or filter denoted [W]. Each neuron of the output matrix [O] is connected to part of the input matrix [I]; this part is called “input sub-matrix” or else “receptive field of the neuron” and it has the same dimensions as the filter [W]. The filter [W] is common to all of the neurons of an output matrix [O].

The values of the output neurons O_{i,j} are given by the following relationship:

O_{i,j}=g(Σₜ₌₀^{(K}^{ₓ}⁻¹⁾Σₗ₌₀^{(K}^{_{y}}⁻¹⁾x_{i·s}_{ᵢ}_{+t,j·s}_{ⱼ}₊ₗ·w_{t,l})

In the above formula, g( ) denotes the activation function of the neuron, while sᵢ and sⱼ denote the vertical and horizontal stride parameters, respectively. Such a stride corresponds to the stride between each application of the convolution kernel to the input matrix. For example, if the stride is greater than or equal to the size of the kernel, then there is no overlap between each application of the kernel. It will be recalled that this formula is valid in the case where the input matrix has been processed so as to add additional rows and columns (padding). The filter matrix [W] is formed by the synaptic coefficients w_{t,l} of ranks t=0 to Kₓ−1 and I=0 to K_{y}−1.

By way of example, the ReLu function is defined as network activation function such that g(x)=0 if x<0 and g(x)=x if x≥0. The use of the ReLu function as activation function generates a relatively significant amount of zero data in the intermediate layers of the network. This justifies the interest in exploiting this characteristic to reduce the number of computing cycles by avoiding carrying out multiplications with zero data when computing a weighted sum of a neuron in order to save processing time and energy. The use of this type of activation function makes the computer circuit compatible with the technical solution according to the invention applied to data propagated or backpropagated in the neural network.

Moreover, it is possible to carry out “pruning” operations during the phase of training the network. This is a mechanism for zeroing synaptic coefficients having values less than a certain threshold. The use of this mechanism makes the computer circuit compatible with the technical solution according to the invention applied to synaptic weights.

In general, each convolutional layer of neurons denoted Cₖ may receive a plurality of input matrices on multiple input channels of rank p=0 to P, with P a positive integer, and/or compute multiple output matrices on a plurality of output channels of rank q=0 to Q, with Q a positive integer. [W]_{p,q},^{k} denotes the filter corresponding to the convolution kernel that connects the output matrix [O]_{q} to an input matrix [I]p in the layer of neurons Cₖ. Various filters may be associated with various input matrices, for the same output matrix.

FIGS. 2a-2b illustrate a case where a single output matrix (and therefore a single output channel) [O] is connected to a single input matrix [I] (and therefore a single input channel).

FIG. 2c illustrates another case where multiple output matrices [O]_{q} are each connected to multiple input matrices [I]p. In this case, each output matrix [O]_{q} of the layer Cₖ is connected to each input matrix [I]p via a convolution kernel [W]_{p,q},^{k} which may be different depending on the output matrix.

Moreover, when an output matrix is connected to multiple input matrices, the convolution layer carries out, in addition to each convolution operation described above, summing of the output values of the neurons obtained for each input matrix. In other words, the output value of an output neuron (or also called output channels) is in this case equal to the sum of the output values obtained for each convolution operation applied to each input matrix (or also called input channels).

The values of the output neurons O_{i,j} of the output matrix [O]_{q} are in this case given by the following relationship:

O_{i,j,q}=g(Σₚ₌₀^{P}Σₜ₌₀^{(K}^{ₓ}⁻¹⁾Σₗ₌₀^{(K}^{_{y}}⁻¹⁾x_{p,i·s}_{ᵢ}_{+t,j·s}_{ⱼ}₊ₗ·w_{p,q,t,l})

With p=0 to P the rank of an input matrix [I]p connected to the output matrix [O]_{q} of the layer Cₖ of rank q=0 to Q via the filter [W]_{p,q},^{k} formed of the synaptic coefficients w_{p,q,t,l} of ranks t=0 to Kₓ−1 and I=0 to K_{y}−1.

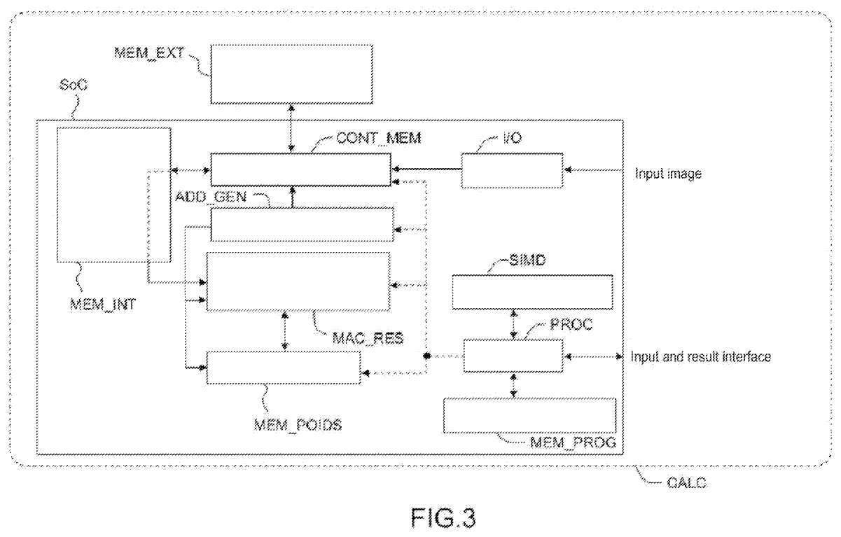

FIG. 3 illustrates one example of a block diagram of the general architecture of the computing circuit of a convolutional neural network according to the invention.

The computing circuit of a convolutional neural network CALC comprises an external volatile memory MEM_EXT for storing the input and output data of all of the neurons of at least the layer of the network currently being computed during an inference or learning phase and an integrated system-on-chip SoC.

The integrated system SoC comprises a computing network MAC_RES consisting of a plurality of computing units for computing neurons of a layer of the neural network, an internal volatile memory MEM_INT for storing the input and output data of the neurons of the layer currently being computed, a weight memory stage MEM_POIDS comprising a plurality of internal non-volatile memories of rank n=0 to N−1 denoted MEM_POIDSₙ for storing the synaptic coefficients of the weight matrices, a memory control circuit CONT_MEM connected to all of the memories MEM_INT, MEM_EXT and MEM_POIDS in order to act as interface between the external memory MEM_EXT and the system-on-chip SoC, a set of address generators ADD_GEN for organizing the distribution of data and synaptic coefficients in a computing phase and for organizing the transfer of the results computed from the various computing units of the computing network MAC_RES to one of the memories MEM_EXT or MEM_INT.

The system-on-chip SoC notably comprises an image interface denoted I/O for receiving input images for the entire network in an inference or learning phase. It should be noted that the input data received via the interface I/O are not limited to images but may more generally be of a diverse nature.

The system-on-chip SoC also comprises a processor PROC for configuring the computing network MAC_RES and the address generators ADD_GEN according to the type of neural layer computed and the computing phase carried out. The processor PROC is connected to an internal non-volatile memory MEM_PROG that contains the computer programming able to be executed by the processor PROC.

Optionally, the system-on-chip SoC comprises a computing accelerator of SIMD (Single Instruction on Multiple Data) type connected to the processor PROC in order to improve the performance of the processor PROC.

The external and internal data memories MEM_EXT and MEM_INT may be implemented with DRAM memories.

The internal data memory MEM_INT may also be implemented with SRAM memories.

The processor PROC, the accelerator SIMD, the programming memory MEM_PROG, the set of address generators ADD_GEN and the memory control circuit CONT_MEM form part of the means for controlling the computing circuit of a convolutional neural network CALC.

The weight data memories MEM_POIDSₙ may be implemented with memories based on an emerging NVM technology.

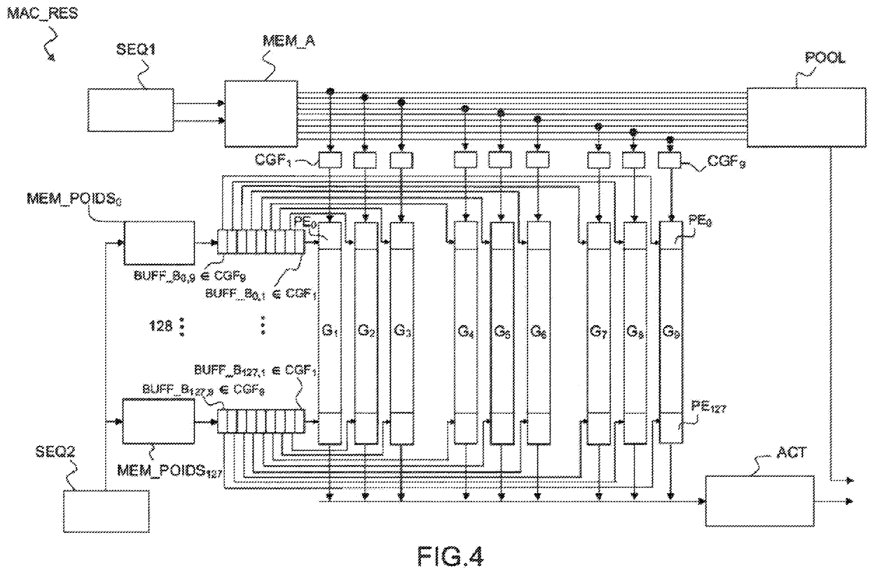

FIG. 4 illustrates one example of a block diagram of the computing network MAC_RES implemented in the system-on-chip SoC according to a first embodiment of the invention. The computing network MAC_RES comprises a plurality of groups of computing units denoted Gⱼ of rank j=1 to M, with M a positive integer, and each group comprises a plurality of computing units denoted PEₙ of rank n=0 to N−1, with N a positive integer representing the number of output channels.

Without loss of generality, the exemplary implementation illustrated in FIG. 4 comprises 9 groups of computing units, each group comprises 128 computing units denoted PEₙ. This design choice makes it possible to cover a wide range of convolution types such as 3×₃ stride1, 3×₃ stride2, 5×₅ stride1, 7×₇ stride2, 1×1 stride1 and 11×₁₁ stride4 based on the spatial parallelism provided by the groups of computing units and all while computing 128 output channels in parallel.

During the computing of a layer of neurons, each of the groups of computing units Gⱼ receives the input data xᵢⱼ from a memory integrated into the computing network MAC_RES denoted MEM_A comprising one of the input data xᵢⱼ of a layer currently being computed. The memory MEM_A receives a subset of the input data from the external memory MEM_EXT or from the internal memory MEM_INT. Input data from one or more input channels are used to compute one or more output matrices on one or more output channels.

The memory MEM_A comprises a write port connected to the memories MEM_EXT or MEM_INT and 9 read ports each connected to a flow management circuit CGF that is itself connected to a group of computing units Gⱼ. For each group Gⱼ of computing units PEₙ, the flow management circuit CGF is configured to distribute, in each computing cycle, non-zero input data xᵢⱼ from the first data memory MEM_A to the computing units PEₙ belonging to the group Gⱼ.

As described above, the system-on-chip SoC comprises a plurality of weight memories MEM_POIDSₙ of rank n=0 to N−1. The computer circuit furthermore comprises a plurality of weight buffer memories denoted BUFF_Bₙⱼ of rank n=0 to N−1 and of rank j=1 to M. The buffer memory of rank n and j receives the weights from the weight memory MEM_POIDSₙ of rank n in order to distribute them to the computing unit PEₙ of the same rank n belonging to the group Gⱼ of rank j. By way of example, the weight memory of rank 0 MEM_POIDS₀ is connected to 9 weight buffer memories BUFF_B₀ⱼ. The weight buffer memory BUFF_B₀₁ is connected to the computing unit PE₀ of the first group of computing units G₁. The weight buffer memory BUFF_B₀₂ is connected to the computing unit PE₀ of the second group of computing units G₂, and so on. The set of weight buffer memories BUFF_B₀ⱼ of rank j belong to the flow management circuit CGF; associated with the group of the same rank j.

Each flow circuit CGF; associated with a group of computing units Gⱼ furthermore generates skip information in the form of one or more signals for controlling the reading of the synaptic coefficients on the basis of the skip information generated by each flow circuit CGFⱼ.

This makes it possible to synchronize, at the input of each computing unit PEₙ of rank n, the distribution of the synaptic weights wᵢⱼ from a weight memory MEM_POIDSₙ of rank n with the distribution of the non-zero input data xᵢⱼ from the first data memory MEM_A via the flow circuit CGFⱼ. The computer thus computes said weighted sum in the correct order.

Each weight memory of rank n MEM_POIDSₙ contains all of the weight matrices [W]_{p,n},^{k} associated with the synapses connected to all of the neurons of the output matrices of a layer of neurons of rank k of the network. Said output matrix corresponding to the output channel of the same rank n, with n an integer varying from 0 to 127 in the exemplary implementation of FIG. 4.

Advantageously, the computing network MAC_RES notably comprises an average or maximum computing circuit, denoted POOL, for carrying out the “Max Pool” or “Average Pool” layer computations. A “Max pooling” processing operation on an input matrix [I] generates an output matrix [O] of size smaller than that of the input matrix by taking the maximum of the values of a sub-matrix [x1] for example of the input matrix [I] in the output neuron O₀₀. An “average pooling” processing operation computes the average value of all of the neurons of a sub-matrix of the input matrix.

Advantageously, the computing network MAC_RES notably comprises a circuit for computing an activation function denoted ACT, generally used in convolutional neural networks. The activation function g(x) is a non-linear function, such as a ReLu function for example.

To simplify the description of the first embodiment of the invention, a limit will be drawn below to the description of the solution with a single computing unit PE corresponding to a single group of computing units and a single output channel.

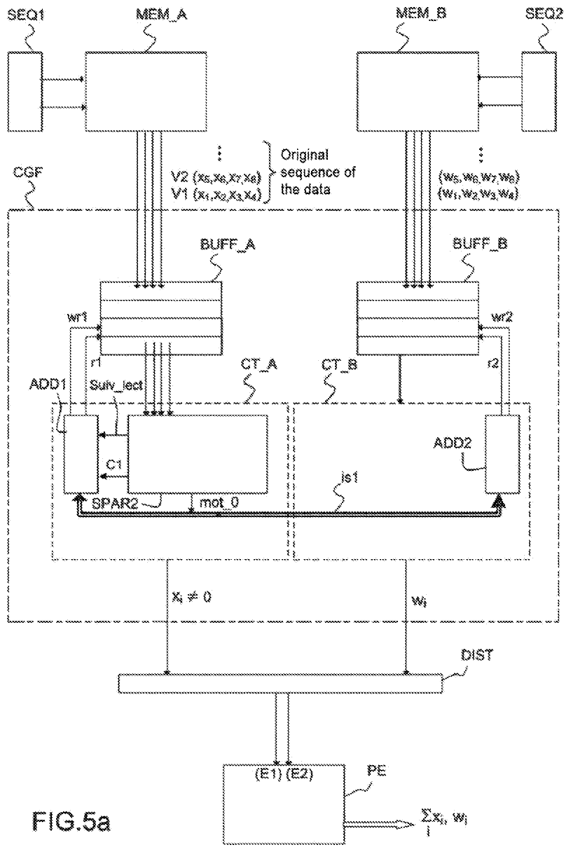

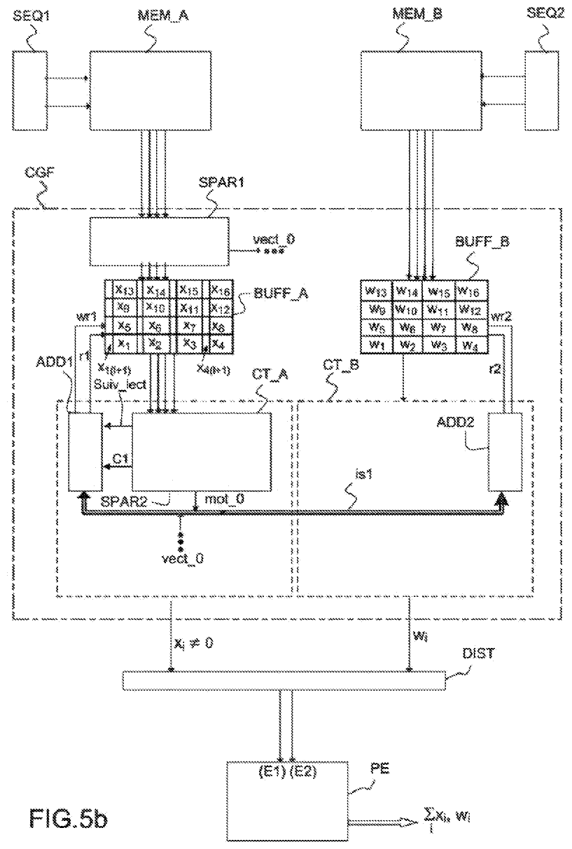

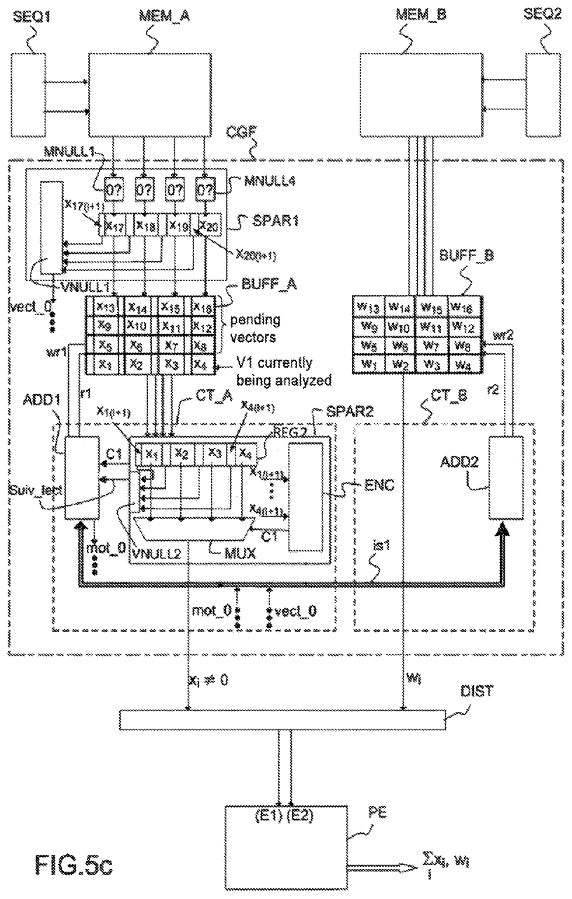

The input data xᵢⱼ received by a layer currently being computed constitute the first operand of the MAC operation carried out by the computing unit PE. The synaptic weights wᵢⱼ connected to a layer currently being computed constitute the second operand of the MAC operation carried out by the computing unit PE. FIG. 5a illustrates the implementation of the flow management circuit CGF exploiting the low density of non-zero values for the data xᵢⱼ in order to limit the number of cycles for computing a weighted sum.

The computing circuit CALC comprises a first data memory MEM_A for storing the first set of data corresponding to the input data xᵢⱼ; a second data memory MEM_B (corresponding to MEM_POIDS₀) for storing the second set of data corresponding to the synaptic weights wᵢⱼ; and a computing unit PE₀ for computing a sum of the input data xᵢⱼ weighted by the synaptic weights wᵢⱼ.

The computing circuit CALC furthermore comprises a flow management circuit CGF configured to distribute, in each cycle, a non-zero input datum xᵢⱼ from the first data memory MEM_A to the computing unit PE so as not to carry out the multiplication operations with zero input data. In addition, the flow management circuit CGF is configured to generate at least one skip indicator depending on the number of zero data skipped between two successively distributed non-zero data xᵢⱼ. The one or more skip indicators then make it possible to generate a new distribution sequence comprising only non-zero data. More generally, the skip indicators are used to synchronize the distribution of the synaptic weights from the second memory MEM_B in order to multiply an input datum xᵢⱼ by the corresponding synaptic weight wᵢⱼ.

By way of example, the input data of an input matrix [I] in the external memory MEM_A are arranged such that all of the channels for one and the same pixel of the input image are arranged sequentially. For example, if the input matrix is a raster image of size N×N formed of 3 input channels of RGB colors (Red, Green,Blue) the input data x_{i,j} are arranged as follows:
x_{00R} x_{00G} x_{00B}, x_{01R} x_{01G} x_{01B}, x_{02R} x_{02G} x_{02B}, . . . , x_{0(N-1)R} x_{0(N-1)G} x_{0(N-1)B}
x_{10R} x_{10G} x_{10B}, x_{11R} x_{11G} x_{11B}, x_{12R} x_{12G} x_{12B}, . . . , x_{1(N-1)R} x_{1(N-1)G} x_{1(N-1)B}
x_{20R} x_{20G} x_{20B}, x_{21R} x_{21G} x_{21B}, x_{22R} x_{22G} x_{22B}, . . . , x_{2(N-1)R} x_{2(N-1)G} x_{2(N-1)B}
x_{(N-1)0R} x_{(N-1)0G} x_{(N-1)0B}, x_{(N-1)1R} x_{(N-1)1G} x_{(N-1)1B}, . . . , x_{(N-1) (N-1)R} x_{(N-1) (N-1)G} x_{(N-1) (N-1)B}

The second data memory MEM_B (corresponding to MEM_POIDS₀) is connected to a weight buffer memory BUFF_B for storing a subset of the weights wᵢⱼ from the memory MEM_B.

The computer circuit comprises a first sequencer circuit SEQ1 able to control reading from the first data memory MEM_A according to a first predefined addressing sequence. The first addressing sequence constitutes a raw sequence before the parsimony processing that is the subject of the invention.

Similarly, the computer circuit furthermore comprises a second sequencer circuit SEQ2 able to control reading from the second data memory MEM_B according to a second predefined addressing sequence.

The computer circuit furthermore comprises a distribution circuit DIST associated with each computing unit PE in order to successively deliver thereto a new pair of associated first and second data at the output of the flow management circuit CGF.

The flow management circuit CGF receives the data xᵢⱼ in the form of vectors V=(a1, a2, a3, . . . aL) formed of L data, with L a strictly positive integer. By way of example, L=4 is taken, and the flow management circuit CGF thus first receives and processes a first vector V1=(x_{00R} x_{00G} x_{00B}, x_{01R}), then a second vector V₂=(x_{01G} x_{01B}, x_{02R} x_{02G}) and so on until the last vector Vₖ=(x_{(N-1) (N-2)B}, x_{(N-1) (N-1)R}, x_{(N-1) (N-1)G}, x_{(N-1) (N-1)B}).

To simplify the illustration of the embodiments of the invention, we will consider the following sequence: V₁=(x₁, x₂, x₃, x₄), V₂=(x₅, x₆, x₇, x₈), V₃=(x9, x₁₀, x₁₁, x₁₂) . . . Vₖ=(x₄₍ₖ₋₁₎₊₁, x₄₍ₖ₋₁₎₊₂, x₄₍ₖ₋₁₎₊₃, x₄₍ₖ₋₁₎₊₄₎, with k a non-zero natural integer.

The flow management circuit CGF comprises a first buffer memory BUFF_A for storing all or some of the first data delivered sequentially by the first sequencer circuit SEQ1 and a second buffer memory BUFF_B for storing all or some of the second data delivered sequentially by the second circuit sequencer SEQ2.

The flow management circuit CGF furthermore comprises a first processing circuit CT_A for processing a vector V1 stored in the buffer memory BUFF_A and a second processing circuit CT_B for processing the synaptic coefficients stored in the buffer memory BUFF_B.

The buffer memory BUFF_A works in accordance with a “first in first out” (FIFO) principle.

The first processing circuit CT_A comprises a first circuit for controlling read and write pointers ADD1 of the first buffer memory BUFF_A. The first processing circuit CT_A carries out the following operations in order to obtain a new sequence not comprising zero input data xᵢ. First of all, the first processing circuit CT_A analyzes the first data xᵢ delivered by said first sequencer circuit SEQ1 in the form of vectors in order to search for the first zero data and define a first skip indicator is1 between two successive non-zero data. Second of all, the first processing circuit CT_A is configured to control the transfer, to the distribution circuit DIST, of a first datum read from the first data buffer memory BUFF_A on the basis of said first skip indicator is1.

The second processing circuit CT_B symmetrically comprises a second circuit ADD2 for controlling read and write pointers of the second buffer memory. The processing circuit CT_B is able to control the transfer, to the distribution circuit, of a second datum read from the second data buffer memory BUFF_B on the basis of said first skip indicator is1.

Advantageously, it is conceivable, for one particular embodiment, for the second processing circuit CT_B to carry out operations of analyzing the second data (in this case, these are the weights wᵢ) delivered by the second sequencer circuit SEQ2 in order to search for the second zero data and define a second skip indicator is2 between two successive non-zero data. In addition, the second processing circuit CT_B controls the transfer, to the distribution circuit, of a second datum read from the second data buffer memory BUFF_B on the basis of said first and second skip indicators is1 and is2. In this case, the assembly of the first and of the second processing circuit CT_B and CT_A is able to control the transfer, to the distribution circuit DIST, of a second datum read from the second data buffer memory on the basis of said first and second skip indicators.

FIG. 5b illustrates a first embodiment of the invention in which the parsimony analysis is carried out only on the first addressing sequence of the first input data xᵢ in order to generate a first skip indicator is1.

The transfer, to the distribution circuit, of a first datum xᵢ read from the first data buffer memory MEM_A is carried out on the basis of the first skip indicator is1. The transfer, to the distribution circuit DIST, of a second datum wᵢ read from the second data buffer memory BUFF_B is carried out on the basis of the first skip indicator is1. Reference is made here to a master-slave arrangement, since the new distribution sequence of the set of second data is dependent on the first skip indicator is1 resulting from the analysis of the addressing sequence of the first input data xᵢ.

The first processing circuit CT_A comprises a data parsimony management stage SPAR2 configured to generate a word skip signal mot_0 between two successive non-zero data intended for the two pointer control circuits ADD1 and ADD2. The word skip signal mot_0 constitutes a first component of the first skip indicator is1.

Advantageously, the flow management circuit CGF comprises, upstream of the first buffer memory BUFF_A, a vector parsimony management stage SPAR1 configured to generate a vector skip signal vect_0 intended for the two pointer control circuits ADD1 and ADD2 when a vector V1 is zero. The vector skip signal vect_0 constitutes a second component of the first skip indicator is1.

The vector parsimony management stage SPAR1 is configured to process the data vectors V provided in succession by the data memory MEM_A by detecting whether a vector V=(x₁, x₂, x₃, x₄) is a zero vector in the sense that x₁=x₂=x₃=x₄=0. When a zero vector is detected by the first vector parsimony management stage SPAR1, the latter generates a vector skip signal vect_0 to the address generator ADD1 so as not to write the detected zero vector to the buffer memory BUFF_A and move on to processing the following vector. This thus gives, in the memory BUFF_A, a stack of vectors V of four data xᵢ comprising at least one non-zero datum.

To detect a zero vector, it is possible to compute, for each datum x₁, x₂, x₃, x₄ of the vector being currently being processed, a zero datum indicator within the vector parsimony management stage SPAR1 or beforehand in the data flow chain. For each datum x₁, x₂, x₃, x₄ of the vector V, the zero datum indicator may take the form of an additional bit concatenated to the bit word constituting the datum itself.

Without loss of generality, in the illustrations presented, the computing of the zero datum indicator is an operation internal to the vector parsimony management circuit SPAR1. However, it is possible to compute and pair, with each input datum xᵢ, the zero datum indicators outside the flow control circuit CGF. By way of example, if the datum x₁ is coded on I bits, x1₍ₗ₊₁₎ denotes the zero datum bit of the datum x₁.

The zero datum indicator x1₍ₗ₊₁₎ has a first state NO corresponding to a zero datum and a second state N1 corresponding to a non-zero datum.

The second data parsimony management stage SPAR2 is configured to successively process the vectors stored in the buffer memory BUFF_A by distributing, successively and in each computing cycle, a non-zero datum of the vector currently being processed.

The second data parsimony management stage SPAR2 provides a second function of generating of a word skip signal mot_0 between two successive non-zero data. The combination of the vector skip signal vect_0 and of the word skip signal mot_0 forms the first skip indicator is1. The first skip indicator is1 allows the system to extract a new addressing sequence without zero data to the address generator ADD1. The address generator ADD1 thus controls the transfer, to the distribution circuit, of a first datum read from the first data buffer memory BUFF_A on the basis of the first skip indicator is1 to the computing unit PE.

In addition, the propagation of the skip indicator is1 to the address generator ADD2 associated with the processing circuit CT_B makes it possible to synchronize the distribution of the weights wᵢⱼ to the computing unit PE from the buffer memory BUFF_B.

The data parsimony management stage SPAR2 provides another function of generating a signal for triggering reading of the following vector suiv_lect when all of the non-zero data of the vector V have been sent to the distribution member DIST. The signal suiv_lect is propagated to the address generator ADD1 to trigger the processing of the following vector from the buffer memory BUFF_A following the end of the analysis of the vector currently being processed.

The proposed solution thus makes it possible to minimize the number of computing cycles carried out to compute a weighted sum by avoiding carrying out multiplications with zero data xᵢⱼ following the detection of these zero data, and the synchronization of the distribution of the weights wᵢⱼ by way of at least one item of read skip information.

The solution described according to the invention is symmetrical in the sense that it is possible to invert the data and the weights in the detection and synchronization mechanism. In other words, it is possible to invert the concept of master-slave between the data xᵢ and the weights wᵢ. It is thus possible to detect the zero weights wᵢⱼ and synchronize the reading of the data xᵢ according to skip information computed based on the processing of the weights wᵢ.

FIG. 5c shows one example of an implementation of the vector parsimony management stage and of the data parsimony management stage, belonging to the flow management circuit according to the invention.

We illustrate the example in which a vector V comprises 4 values. The vector parsimony management stage SPAR1 comprises 4 zero datum detection circuits MNULL1, MNULL2, MNULL3 and MNULL4, each intended to compute the zero datum indicator xi₍ₗ₊₁₎ of a datum belonging to the vector V received by the flow management circuit CGF. By way of example, MNULL1 receives the datum x1 at its input and generates, at its output, x1 concatenated with a zero datum indicator bit x1₍ₗ₊₁₎=1 if x1 is zero and x1₍ₗ₊₁₎=0 if x1 is non-zero. A zero datum detection circuit MNULL may be implemented with logic gates so as to form a combinatorial logic circuit.

In the example of FIG. 5c, the zero datum detection circuits have been integrated into the vector parsimony management stage SPAR1, but this is not limiting as it is possible to compute the zero datum indicator x1₍ₗ₊₁₎ upstream of the flow management circuit CGF and even upstream of the storage memory MEM_A.

In addition, the vector parsimony management stage SPAR1 comprises a register REG1 that stores the vector currently being analyzed by SPAR1 in the following form V1=(x1₍ₗ₊₁₎x1, x2₍ₗ₊₁₎x2, x3₍ₗ₊₁₎x3, x4₍ₗ₊₁₎x4).

The vector parsimony management stage SPAR1 furthermore comprises a zero vector detection logic circuit VNULL1 having 4 inputs for receiving the set of zero datum indicators xᵢ₍ₗ₊₁₎ and an output for generating the vector skip signal vect_0 indicating whether or not the vector V is zero. A zero vector is understood to mean a vector V1=(x1₍ₗ₊₁₎x1, x2₍ₗ₊₁₎x2, x3₍ₗ₊₁₎x3, x4₍ₗ₊₁₎x4) such that x1=x2=x3=x4=0 or, in other words, a vector such that the set of zero value indicators xi₍ₗ₊₁₎ belonging to said vector are in the first state N1. The vector skip signal vect_0 thus controls the first memory management circuit ADD1 so as not to write, to the buffer memory BUFF_A, the zero vectors from the first memory MEM_A.

The first parsimony management stage SPAR_1 thus carries out a first filtering step so as to carry out read skips in vectors of 4 data when a zero vector is detected.

In steady state, the buffer memory BUFF_A then stores the data arranged in successive vectors V, each comprising at least one non-zero datum. The transition to reading from one vector to a following vector from the buffer memory BUFF_A is controlled by the memory management circuit ADD1, and the order of the reading of the stored vectors is organized in accordance with the principle of a FIFO “first in first out”.

On the other hand, the data parsimony management stage SPAR2 comprises a register REG2 that stores the vector currently being processed by SPAR2. The data parsimony management stage SPAR2 is configured to successively process the vectors V from the buffer memory BUFF_A as follows:
detecting the position of the first non-zero datum belonging to the vector currently being processed by way of the zero datum indicator bit;
controlling the distribution of said detected non-zero datum to the computing unit PE;
setting the zero datum indicator of the input datum distributed in the vector V currently being processed to the first state NO,
computing and generating a word skip signal mot_0 between two successive non-zero data.

For a vector V currently being analyzed, the steps described above are reiterated by SPAR2 until all of the zero datum indicators of the vector are in the state NO, indicating that all of the non-zero data of the vector V have been distributed and then triggering the processing of the following vector from BUFF_A. The data parsimony management stage SPAR2 provides this function by generating the signal for triggering reading of the following vector suiv_lect when all of the zero datum indicators of the vector are in the state NO.

To carry out the various functions detailed above, the data parsimony management stage SPAR2 comprises a priority encoder stage ENC configured to iteratively generate a distribution control signal c1 corresponding to the index of the first non-zero input datum of the vector V1. Indeed, the encoder stage ENC receives, at input, the zero datum indicators xᵢ₍ₗ₊₁₎ of the vector currently being analyzed in order to generate said index.

The distribution control signal c1 is then propagated as input to the memory management circuit ADD1 in order to generate the second skip indicator mot_0, followed by setting of the zero datum indicator of the input datum distributed in the vector V1 stored in the register Reg2 to the first state N0 following distribution thereof.

The second data parsimony management stage SPAR2 furthermore comprises a distribution member MUX controlled by the distribution control signal c1. A multiplexer with 4 inputs each receiving a datum xᵢ of the vector V and with one output may be used to implement this functionality.

The second data parsimony management stage SPAR2 furthermore comprises a second zero vector detection logic circuit VNUL2 for generating a signal for triggering reading of the following vector suiv_lect when all of the zero datum indicators of the data belonging to the vector V1 currently being processed are in the first state N0 and controlling the memory BUFF_A through the memory management circuit ADD1 so as to trigger the processing of the following vector V2 by SPAR2 in the next cycle.

At the same time for each distributed non-zero datum xᵢⱼ, the two skip indicators mot_0 and vect_0 form the two components of the first skip indicator is1. The latter is propagated to the second memory management circuit ADD2 that controls the reading of the buffer memory BUFF_B. This makes it possible to distribute the weight wᵢⱼ associated with the distributed datum xᵢⱼ according to the reading sequence initially provided by the sequencers SEQ1 and SEQ2.

By way of illustration, consideration is given to the following sequence of data formed of the successive vectors V₁=(x₁=4, x₂=0, x₃=0, x₄=2), V₂=(x₅=0, x₆=0, x₇=0, x₈=0), V₃=(x₉=0, x₁₀=1, x₁₁=0, x₁₂=3). The first initially predefined addressing sequence that governs the reading of the data from MEM_A is as follows: x₁, x₂, x₃, x₄, x₅, x₆, x₇, x₈, x₉, x₁₀, x₁₁, x₁₂. The second initially predefined addressing sequence that governs the reading of the weights from MEM_B is w₁, w₂, w₃, w₄, w₅, w₆, w₇, w₈, w₉, w₁₀, w₁₁, w₁₂. The new addressing sequence that governs the reading of the data from MEM_A after processing by the parsimony management circuit is: x₁, x₄, x₁₀, x₁₂ and for the weights wᵢ, w₄, w₁₀, w₁₂. The skip indicator is1=mot_0+vect_0 successively takes the following values:
1^{st} cycle: is1=mot_0+vect_0×4=0+0=0
2^{nd} cycle: is1=mot_0+vect_0=2+0×₄=2
3^{rd} cycle: is1=mot 0+vect_0=1+1×₄=5
4^{th} cycle: is1=mot_0+vect_0=1+0×₄=1

In some embodiments applied to a convolutional neural network, it is possible to have an initial sequencing for the data and the weights in which multiple weights are associated with the same datum. Indeed, for a convolution n×n, an input datum xᵢ is multiplied by n different weights of the weight matrix. Thus, a unit skip in the skip indicator is1 in the first sequence of data xᵢ corresponds to n skips in the second addressing sequence for the weights wᵢ.

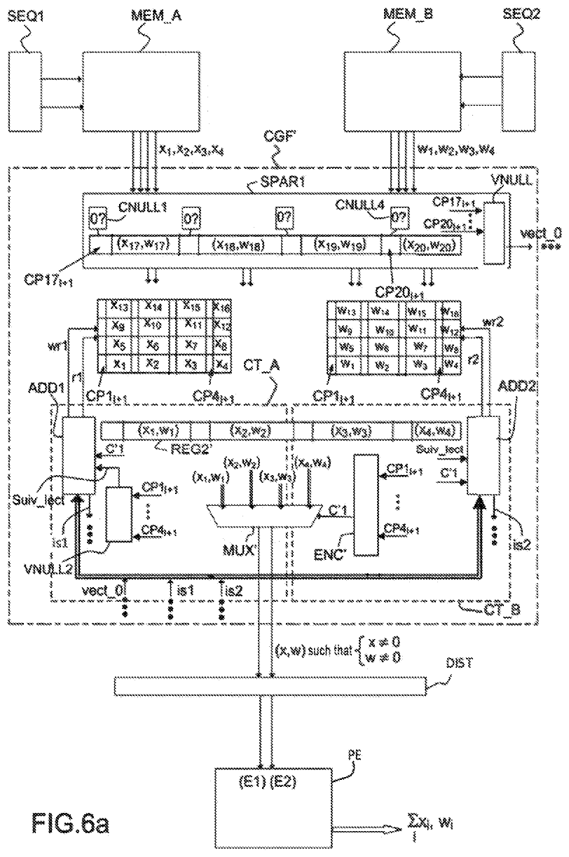

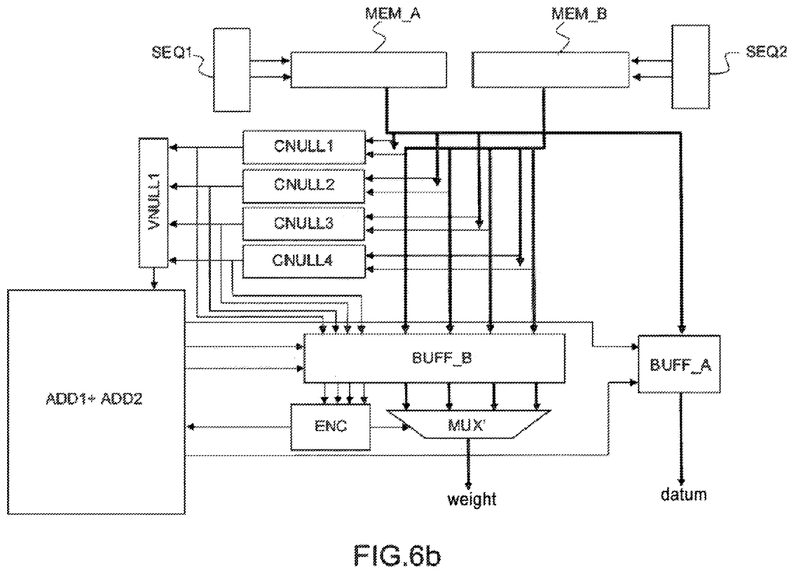

FIG. 6a shows a second embodiment of the data flow management circuit CGF′ according to the invention. The specific feature of this embodiment is the joint parsimony management of the first set of input data (in the illustrated case, these are data from a layer in the network xᵢ) and of the second set of input data (in the illustrated case, these are weights or synaptic coefficients wᵢ).

Similarly to the first embodiment, the computer circuit CALC in FIG. 6a comprises a first memory MEM_A for storing the first data xᵢ and a first sequencer SEQ1 for controlling the reading of the memory MEM_A according to a first predefined sequence.

Similarly to the first embodiment, the computer circuit CALC in FIG. 6a comprises a second memory MEM_B for storing the second data wᵢ and a second sequencer SEQ2 for controlling the reading of the memory MEM_B according to a second predefined sequence.

The advantage of the second embodiment is the simultaneous management of the low density of non-zero values of the two sets of data constituting the operands of the multiplications for a weighted sum. The result of compressing the data distribution sequence over time is thus greater than that in the first embodiment. Indeed, in the master-slave arrangement described above, the low density of non-zero values is taken into account only for one of the two sets of data. In the second embodiment, described later, the flow management circuit CGF′ processes the two sets simultaneously. To this end, based on the first and the second initial distribution sequence provided by SEQ1 and SEQ2, each datum xᵢ is paired with the corresponding weight wᵢ to form a pair (xᵢ, wᵢ). The vectors V′₁, V′₂, V′₃, V′ₖ correspond in this case to vectors of pairs V′₁=((x₁,w₁), (x₂,w₂), (x₃,w₃), (x₄,w₄)), V′₂=((x₅,w₅), (x₆,w₆), (x₇,w₇), (x₈,w₈)), V′₃=((x₉,w₉), (x₁₀,w₁₀), (x₁₁,w₁₁), (x₁₂,w₁₂)) and so on.

In the second embodiment, the second processing circuit CT_B is able to analyze the second data delivered by said second sequencer circuit in order to search for the second zero data and define a second skip indicator between two successive non-zero data, and to control the transfer, to the distribution circuit, of a second datum read from the second data buffer memory on the basis of said first and second skip indicators.

The second processing circuit CT_B is thus able to control the transfer, to the distribution circuit, of a weight wᵢ read from the second data buffer memory BUFF_B on the basis of the first and the second skip indicators is1 and is2. Similarly for the first processing circuit CT_A, the transfer of the data xᵢ to a computing unit PE is controlled on the basis of the first and the second skip indicators is1 and is2.

The vector parsimony management stage SPAR1 comprises 4 zero pair detection circuits CNULL1, CNULL2, CNULL3 and CNULL4, each intended to compute the zero pair indicator CP1₍ₗ₊₁₎=(x₁,w₁)₍ₗ₊₁₎ of a pair of data belonging to the vector V received by the flow management circuit CGF′. The term zero pair is understood to mean each pair having at least one zero component.

For example, if CNULL1 receives the pair (x₁=1,w₁=0) (or (x₁=0,w₁=1)) at its input, it generates, at its output, the pair (x₁,w₁) concatenated with a zero pair indicator bit CP1₍ₗ₊₁₎=(x₁,w₁)₍ₗ₊₁₎ in a first logic state N′0.

On the other hand, if CNULL1 receives the pair (x₁=1,w₁=2) at its input, it generates, at its output, the pair (x₁,w₁) concatenated with a zero pair indicator bit CP1₍ₗ₊₁₎=(x₁,w₁)₍ₗ₊₁₎ in a second logic state N′1.

As an alternative, it is possible to pair the zero pair indicator with each of the data forming the pair so as to allow storage of the data in separate memories, such that each first or second datum is concatenated with an associated zero pair indicator bit.

A zero pair detection circuit CNULL may be implemented with logic gates so as to form a combinatorial logic circuit.

In the example of FIG. 6a, the zero pair detection circuits have been integrated into the vector parsimony management stage SPAR1, but this is not limiting as it is possible to compute the zero datum indicator x1₍ₗ₊₁₎ upstream of the flow management circuit CGF′ and even upstream of the first and the second storage memory MEM_A and MEM_B.

The pair vector parsimony processing carried out by the vector parsimony management stage SPAR1 is carried out in a manner similar to that of the first embodiment. The difference is that the test is carried out on zero pair indicators in the second embodiment. Thus, only vectors comprising at least one pair having two non-zero components are transferred to the buffer memories BUFF_A and BUFF_B.

To implement FIFO-type buffer memories, it is possible to store the data xᵢ and the weights wᵢ in the form of a pair belonging to a vector of pairs in a common buffer memory MEM_AB. It is also conceivable (as illustrated here) to keep two separate buffer memories MEM_A and MEM_B the addressing of the read and write pointers of which is managed respectively by the first and the second memory control circuit ADD1 and ADD2.

In the illustrated embodiment, the processing circuits CT_A and CT_B share a register REG2′ for receiving a pair vector currently being analyzed and share a priority encoder circuit ENC′ and a multiplexer MUX′ for successively distributing pairs not having any zero component.

At the level of the processing circuits CT_A and CT_B, the same principle of the first embodiment is applied to the pairs of data and to the zero pair indicators computed beforehand. The new sequence that is obtained then depends on a combination of the first skip indicator is1 linked to the first sequence of the first data (coming from MEM_A) and the second skip indicator is2 linked to the second sequence of the second data (coming from MEM_B).

To carry out the various functions detailed above, the priority encoder stage ENC′ is configured to iteratively generate a distribution control signal c′1 corresponding to the index of the first pair having two non-zero data of the vector V′i currently being processed. Indeed, the encoder stage ENC′ receives, at input, the zero pair indicator CP1₍ₗ₊₁₎=(x₁,w₁)₍ₗ₊₁₎ of the vector currently being analyzed in order to generate said distribution control signal c′1.

The distribution control signal c′1 is then propagated as input to the memory management circuit ADD1 in order to generate the second skip indicator mot_0, followed by setting of the zero pair indicator CP1₍ₗ₊₁₎=(x₁,w₁)₍ₗ₊₁₎ of the input datum distributed in the vector V′ᵢ stored in the register Reg2′ to the first state N′0 following distribution thereof.

The multiplexer MUX′ is controlled by the distribution control signal c′1.

The processing circuits CT_A and CT_B share a zero vector detection logic circuit VNUL2 for generating a signal for triggering reading of the following vector suiv_lect when all of the zero pair indicators CPi₍ₗ₊₁₎=(xᵢ,wᵢ)₍ₗ₊₁₎ of the vector currently being processed in the register REG2′ are in the first state N0′.

We have thus produced a circuit for processing the distribution of data and weights based on the analysis not only of the data but also of the weights, making it possible to even further reduce the size of the data distribution sequence to the computing units PE by avoiding carrying out multiplications by zero data, but also by zero weights.

According to one variant of the embodiment described in FIG. 6a, it is possible to start from a single sequence of pairs [data, weights] that are already paired. The flow management circuit CGF′ thus comprises a common processing circuit CT_AB as there is a single joint sequence to be processed. In this variant, a single skip indicator is generated by the pair processing circuit. This joint skip indicator in the distribution sequence of the pairs [data, weight] makes it possible to avoid distributing pairs including at least one zero value. It is possible to implement this variant using two memory management circuits ADD1 and ADD2 generating the same addresses or, alternatively, a common memory management circuit. The advantage of this variant is that of reducing the complexity and the surface area of the flow management circuit CGF′ compared to the embodiment of FIG. 6a.

FIG. 6b illustrates a third embodiment of the computer according to the invention that makes it possible to reduce the size of the buffer memories of the flow management circuit by taking into account the multiplication of one and the same datum xᵢ by a plurality of weights (or synaptic coefficients).

Indeed, when the computer circuit is dedicated to the computing of a convolutional neural network, of size p×p, with p>1, one and the same datum is used in a multiplication operation with p different weights; thus, in the initial sequence, the datum xᵢ in question is copied p times when it is associated with p different weights. The problem posed by this mechanism is that of increasing the size of the buffer memory MEM_A and therefore the surface area taken up by the integrated circuit comprising the computer circuit.

The embodiment illustrated in FIG. 6b aims to overcome this drawback. Indeed, the flow management circuit is implemented according to the following architecture: instead of a buffer memory operating in FIFO mode and storing the pairs [xᵢ, wᵢ], there are a separate buffer memory operating in FIFO mode (denoted BUFF_B here) dedicated only to the weights and a buffer memory (denoted BUFF_A here) for data.

The joint flow management circuit for data and weights in the described embodiment does not process the data and the weights in pairs. On the one hand, the data buffer memory BUFF_A is a dual-port memory the write pointer of which is incremented by 1 every p cycles modulo the size of the buffer memory BUFF_A. On the other hand, the FIFO buffer memory, denoted BUFF_B, storing the weights also stores the previously computed zero pair indicators in a manner similar to the second embodiment. It will be recalled that, for each pair [xᵢ,wᵢ], if at least one of the two components of the pair is zero, said pair is considered to be a zero pair. A vector is considered to be a zero vector if all of its component pairs are zero according to the definition above.

Data xᵢ are thus written to the buffer memory BUFF_A at a rate p times slower than the writing of the weights wᵢ.

As before, the weights are grouped into vectors (of 4 weights wᵢ for example), while the data buffer BUFF_A has a word width of one datum (here, this is for the data of a unitary data vector xᵢ).

When a vector in the buffer memory BUFF_B (of FIFO type) comprises only the weights of pairs at least one of the components of which is zero, the vector is not loaded into BUFF_B and the vector skip signal is generated in a manner similar to the other embodiments.

The pairs having two non-zero components are selected as previously by way of a priority encoder ENC with a selection criterion based on the non-zero pair indicators, thus making it possible to generate a new distribution sequence of the weights wᵢ to the computing unit PE.

Moreover, the data to be presented to the computing unit PE in the face of each weight are selected by incrementing the read pointer of the data buffer memory BUFF_A by (1+Nₚₛ)/p modulo the size of the buffer memory BUFF_A, with Nₚₛ the number of weights skipped in the new sequence, obtained by way of the priority encoder ENC. Indeed, the encoder ENC selects the weight of the output word from the weight memory BUFF_B, to which is added the number of skipped zero vectors multiplied by 4 (if the width of the analyzed vector is 4 pairs). This thus makes it possible to recover the datum that was present, in the face of the weight selected at output, when this weight is loaded into the weight buffer memory BUFF_B. The operation of this system is therefore equivalent to the solution according to the second embodiment with joint processing of the first and second data, but with a lower storage capacity for the buffer memory BUFF_A.

1. A computing circuit (CALC) for computing a weighted sum of a set of first data (A, X) weighted by a set of second data (B, W) comprising:
at least one first data memory (MEM_A) for storing the first data (A, X);
at least one second data memory (MEM_B) for storing the second data (B, W);
at least one computing unit (PE) configured to carry out the weighted sum computation;
at least one first sequencer circuit (SEQ1) able to control reading from the first data memory according to a first predefined addressing sequence;
at least one second sequencer circuit (SEQ2) able to control reading from the second data memory according to a second predefined addressing sequence;
at least one distribution circuit (DIST) associated with a computing unit for successively delivering thereto a new pair of associated first and second data;
at least one flow management circuit (CGF) comprising:
a plurality of zero datum detection circuits (MNULL1, MNULL2, MNULL3, MNULL4), each configured to detect zero data delivered by said first sequencer circuit;
a first buffer memory (BUFF_A) for storing all or some of the first data delivered sequentially by said first sequencer circuit;
a second buffer memory (BUFF_B) for storing all or some of the second data delivered sequentially by said second sequencer circuit;
a first processing circuit (CT_A) comprising a first circuit (ADD1) for controlling read and write pointers of the first buffer memory and being able:
to analyze the first data delivered by said first sequencer circuit in order to define a first skip indicator (is1) between two successive non-zero data, and
to control the transfer, to the distribution circuit, of a first datum read from the first data buffer memory on the basis of said first skip indicator (is1);
a second processing circuit (CT_B) comprising a second circuit (ADD2) for controlling read and write pointers of the second buffer memory and being able to control the transfer, to the distribution circuit, of a second datum read from the second data buffer memory on the basis of said first skip indicator (is1).

2. The computing circuit (CALC) as claimed in claim 1,
wherein each zero datum detection circuit (MNULL1, MNULL2, MNULL3, MNULL4) is configured to pair, with each first input datum (x₁, x₂, x₃, x₄), a zero datum indicator (x_{1 (l+1)}) having a first state (N0) corresponding to a zero datum and a second state corresponding to a non-zero datum (N1).

3. The computing circuit (CALC) as claimed in claim 1, wherein:
the first sequencer circuit (SEQ1) is configured to deliver the first data in vectors (V1, V2) of N successive data, N being a non-zero natural integer;
the first buffer memory (BUFF_A) is a memory able to store vectors of N data in accordance with a “first in first out” principle,
the first processing circuit (CT_A) comprises
a data parsimony management stage (SPAR2) intended to receive the vectors (V1, V2) from the first buffer memory (BUFF_A) and configured to generate a word skip signal (mot_0) between two successive non-zero data intended for the two pointer control circuits (ADD1, ADD2);
said word skip signal (mot_0) forming a first component of the first skip indicator (is1).

4. The computing circuit (CALC) as claimed in claim 3, wherein the first processing circuit (CT_A) comprises, upstream of the first buffer memory (BUFF_A), a vector parsimony management stage (SPAR1) configured to generate a vector skip signal (vect_0) intended for the two pointer control circuits (ADD1, ADD2) when a vector (V1) is zero;
said vector skip signal (vect_0) forming a second component of the first skip indicator (is1).

5. The computing circuit (CALC) as claimed in claim 4, wherein the vector parsimony management stage (SPAR1) comprises a first zero vector detection logic circuit (VNUL1) configured to generate, from the zero datum indicators (x₁₍ₗ₊₁₎), the vector skip signal (vect_0) when a vector (V1) comprises only zero data.

6. The computing circuit (CALC) as claimed in claim 3, wherein the data parsimony management stage (SPAR2) comprises:
a register (Reg2) for receiving a non-zero vector (V1) at the output of the first buffer memory (BUFF_A);
a priority encoder stage (ENC) configured to carry out the following operations iteratively:
generating a distribution control signal (c1) corresponding to the index of the first non-zero input datum of the vector (V1);
the first pointer control circuit (ADD1) being configured to carry out the following in the same iteration loop:
generating the word skip signal (mot_0) from the distribution control signal (c1);
and setting the zero datum indicator (x1₍ₗ₊₁₎) of the input datum distributed in the vector (V1) stored in the register (Reg2) to the first state (N0) following distribution thereof;
a second zero vector detection logic circuit (VNUL2) for generating a signal for triggering reading of the following vector (suiv_lect) when all of the zero datum indicators (x_{1 (l+1)}) of the data belonging to said vector (V1) are in the first state (N0).

7. The computing circuit (CALC) as claimed in claim 1, intended to compute output data (O_{i,j}) from a layer of an artificial neural network from input data (x_{i,j}), the neural network being formed of a succession of layers each consisting of a set of neurons, each layer being connected to an adjacent layer via a plurality of synapses associated with a set of synaptic coefficients (w_{i,j}) forming at least one weight matrix ([W]_{p,q});
the first set of data (A, X) corresponding to the input data (xᵢ) for a neuron of the layer currently being computed;
the second set of data (B, W) corresponding to the synaptic coefficients (xᵢ) connected to said neuron of the layer currently being computed;
the computing circuit (CALC) comprising:
at least one group of computing units (Gⱼ), each group of computing units (Gⱼ) comprising a plurality of computing units (PEₖ) of rank k=1 to K, with K a strictly positive integer,
a plurality of second data memories (MEM_B, MEM_POIDS) of rank k=1 to K for storing the second set of data (B, W);
each group of computing units (Gⱼ) being connected to a dedicated flow management circuit (CGF) furthermore comprising:
a plurality of second buffer memories (BUFF_B_{0,1}) of rank k=1 to K such that each second buffer memory distributes, to the computing unit (PEₖ) of the same rank k, the input data (B, W) from the second data memory of the same rank k on the basis of at least the first skip indicator (is1).

8. The computing circuit (CALC) as claimed in claim 1, intended to compute output data (O_{i,j}) from a layer of an artificial neural network from input data (x_{i,j}), the neural network being formed of a succession of layers each consisting of a set of neurons, each layer being connected to an adjacent layer via a plurality of synapses associated with a set of synaptic coefficients (w_{i,j}) forming at least one weight matrix ([W]_{p,q});
the first set of data (A, W) corresponding to the synaptic coefficients (wᵢ) connected to said neuron of the layer currently being computed;
the second set of data (B, X) corresponding to the input data (xᵢ) for a neuron of the layer currently being computed;
the computing circuit (CALC) comprising:
at least one group of computing units (Gⱼ), each group of computing units (Gⱼ) comprising a plurality of computing units (PEₖ) of rank k=1 to K, with K a strictly positive integer,
a plurality of first data memories (MEM_A) of rank k=1 to K for storing the first set of data (A, W);
a plurality of flow management circuits (CGF) of rank k=1 to K, each configured such that, for each computing unit (PEₖ) of rank k belonging to a group of computing units (Gⱼ): the flow management circuit of rank k is configured to distribute the non-zero synaptic coefficients from the first data memory of the same rank k to the computing unit of the same rank k.

9. The computing circuit (CALC) as claimed in claim 1, wherein the second processing circuit is able:
to analyze the second data delivered by said second sequencer circuit in order to search for the second zero data and define a second skip indicator (is2) between two successive non-zero data, and
to control the transfer, to the distribution circuit, of a second datum read from the second data buffer memory on the basis of said first and second skip indicators (is1, is2); and wherein
the second processing circuit (CT_B) is able to control the transfer, to the distribution circuit, of a second datum read from the second data buffer memory on the basis of said first and second skip indicators (is1, is2).

10. The computing circuit (CALC) as claimed in claim 9, wherein
the flow management circuit (CGF′) is configured to read the data from the two memories (MEM_A, MEM_B) in vectors of N successive pairs according to the first and second predefined addressing sequence of said data ((x₁,w₁), (x₂,w₂), (x₃,w₃), (x₄,w₄)), N being a non-zero natural integer;
the first and second skip indicator (is1, is2) are obtained by analyzing said vectors such that the two data forming a distributed pair are non-zero.

11. The computing circuit (CALC) as claimed in claim 10, furthermore comprising:
a plurality of zero pair detection circuits (CNUL1, CNUL2, CNUL3, CNUL4) each configured to pair, with each pair of first and second input data ((x₁,w₁), (x₂,w₂), (x₃,w₃), (x₄,w₄)), a zero pair indicator (CP1ₗ₊₁) having a first state (N′0) corresponding to a pair comprising at least one zero datum and a second state (N′1) corresponding to a pair comprising only non-zero data.

12. The computing circuit (CALC) as claimed in claim 10, wherein:
the assembly formed by the first and the second buffer memory (BUFF_A, BUFF_B) is a memory able to store vectors of N pairs in accordance with a “first in first out” principle,
the assembly formed by the first and the second processing circuit (CT_A, CT_B) comprises
a data parsimony management stage (SPAR2) intended to receive the vectors (V′1, V′2) from the assembly of the first and the second buffer memory (BUFF_A, BUFF_B) and configured to generate a word skip signal (mot_0) between two successive pairs having two non-zero data intended for the two pointer control circuits (ADD1, ADD2);
said word skip signal (mot_0) forming a first component of the first skip indicator (is1) and of the second skip indicator (is2).

13. The computing circuit (CALC) as claimed in claim 10, comprising a vector parsimony management stage (SPAR1) upstream of the first and the second buffer memory (BUFF_A, BUFF_B), the vector parsimony management stage (SPAR1) comprising:
a first zero vector detection logic circuit (VNUL1) configured to generate a vector skip signal (vect_0) when a vector (V′₁) comprises only zero data indicators (CP1ₗ₊₁) in the first state (N′0);
said vector skip signal (vect_0) forming a second component of the first skip indicator (is1) and of the second skip indicator (is2).

14. The computing circuit (CALC) as claimed in claim 11, wherein the pair parsimony management stage (SPAR2) comprises:
a register (Reg2′) for receiving a non-zero vector (V′1) at the output of the buffer memory (BUFF_A, BUFF_B);
a priority encoder stage (ENC′) configured to carry out the following operations iteratively:
generating a distribution control signal (c′1) corresponding to the index of the first pair having two non-zero data of the vector (V′1);
at least the first or the second pointer control circuit (ADD1, ADD2) being configured to carry out the following in the same iteration loop:
setting the zero datum indicator (CP1₍ₗ₊₁₎) of the pair of input data distributed in the vector (V′1) stored in the register (Reg2′) to the first state (N′0) following distribution thereof;
a distribution member (MUX′) controlled by the distribution control signal (c′1);
a second zero vector detection logic circuit (VNUL2) for generating a signal for triggering reading of the following vector (suiv_lect) when all of the zero datum indicators (CP1ₗ₊₁) of the pairs belonging to said vector (V′1) are in the first state (N′0).
